(19) United States
(12) Patent Application Publication
(10) Pub. No.: US 2007/0165892 A1
(43) Pub. Date: Jul. 19, 2007

(54) Wireless audio

(75) Inventor: Ronaldus Maria Aarts, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/570,780

(22) PCT Filed: Jun. 22, 2005
(86) PCT No.: PCT/IB05/52044

§ 371 Date: Dec. 18, 2006

(30) Foreign Application Priority Data
Jun. 28, 2004 (EP) 04102997.6

(51) Int. Cl. H04R 25/00

(52) U.S. Cl. 381/315

(57) ABSTRACT

An audio reproduction system comprises a transmitter device (1) and a receiver device (2). The transmitter device (1) determines the envelope signal of an audio signal (Vᵢₙ) of a selected frequency range and transmits the envelope signal (V_{E}) over a communication channel (C). The receiver device (2) combines the received envelope signal (V_{E}) with an oscillator signal (V_{O}) to produce a transducer signal. The communication channel (C) is preferably wireless. The transducer (30) is preferably designed to operate at its resonance frequency so as to achieve maximum efficiency.

The present invention relates to wireless audio equipment. More in particular, the present invention relates to an audio system having one or more components, such as loudspeakers, that can be used without being connected by wires to other components of the audio system. The present invention also relates to a method of transmitting an audio signal, and an adaptation device for adapting a frequency range of an audio signal to a transducer.

The terms “audio system” and “audio reproduction system” are meant to refer to any system capable of producing or reproducing sound using loudspeakers or other transducers. An audio system may incorporate other functions and may therefore also be capable of producing (still and/or moving) images (e.g. video, photos), or be capable of performing other functions, such as data processing.

It is a well-known problem in audio systems that the various constituent units of a system have to be connected by wires. In addition to the AC power leads typically required for the main unit (amplifier) of an audio system, additional wires are necessary for connecting the speaker units to the main unit. While conventional stereo systems have two speaker units that need to be connected to the main unit, modern home video systems typically have five speaker units, including a so-called sub-woofer. As a result, the number of wires is increased, while consumers consider wires to be a hindrance.

The number of wires in audio systems therefore constitutes a problem. It is possible to transmit an audio signal from an amplifier to a loudspeaker unit (or between any other units of an audio system) using wireless technology, for example using modern high-speed digital protocols. However, components for reliably transmitting audio signals are relatively expensive, while the market for audio systems is extremely competitive.

It is therefore an object of the present invention to overcome these and other problems of the Prior Art and to provide an audio system having a relatively inexpensive wireless link.

Accordingly, the present invention provides an audio transmission device comprising:

detector means for detecting the envelope of an audio signal and producing a corresponding envelope signal, and

transmitter means for transmitting the envelope signal.

The audio transmission device of the present invention utilizes the fact that the envelope of an audio signal has a much narrower bandwidth than the audio signal itself. Consequently, a much more economical wireless link may be used to transmit the envelope signal, resulting in a relatively inexpensive audio system.

The detector means may be constituted by an envelope detector known per se, for example a peak detector. In a very economical embodiment, this detector is constituted by a diode.

The audio transmission device of the present invention may be incorporated in a main unit, such as an amplifier, of an audio system, to transmit the envelope signal to a remote unit, for example a unit containing a loudspeaker. The remote unit will comprise suitable means for producing a loudspeaker signal in response to the transmitted envelope signal.

In a preferred embodiment, the audio transmission device of the present invention further comprises a first filter for selecting a frequency range of the audio signal. In this way, only the envelope of a selected frequency range is detected and subsequently transmitted. As a result, the bandwidth required for transmitting the envelope is further reduced. The selection of the frequency band is carried out prior to detecting the envelope.

In an advantageous embodiment, the first filter is arranged for selecting bass frequencies, preferably in a range from 0 Hz to 200 Hz, more preferably from 20 Hz to 120 Hz. In this way, it is ensured that the envelope signal has a narrow bandwidth. However, the present invention is not limited to bass frequencies and may also be applied to higher frequencies, provided that the transmitter means offer sufficient bandwidth.

To remove any artifacts introduced by the envelope detector, and to further reduce the bandwidth of the envelope signal, the audio transmission device of the present invention may further comprise a second filter for filtering the envelope signal before this signal is fed to the transmitter means.

Although the audio transmission device of the present invention may receive a single input signal, typical audio systems use plural input signals, such as L (left) and R (right) in stereo systems. Advantageously, therefore, the audio transmission system may comprise an addition means for combining audio signals. Such an addition means may simply add the input signals, or may use weighed addition or other combination methods which take the type of input signal into account.

As mentioned above, the transmitter means is preferably arranged for wireless transmission, for example by infra-red light, ultrasound or electromagnetic waves (radio waves). A suitable inexpensive technology is the well-known ZigBee® technology.

It is noted that the invention is not limited to wireless transmission and that the envelope signal may be transmitted through wires, for example through AC power leads. In this way, an audio signal could be transmitted from the amplifier to a loudspeaker via the electrical wiring of a building.

In the preferred embodiments discussed above only the envelope signal is transmitted. This is possible as the typically the approximate frequency of the audio signal is either known in advance, or is determined by the first filter mentioned above. In a further advantageous embodiment, however, the audio transmission device further comprises additional detector means for detecting the frequency of the audio signal and producing a corresponding frequency signal, and wherein the transmitter means are arranged for transmitting the frequency signal.

By transmitting both an envelope signal and a frequency signal, a more accurate reconstruction of the audio signal is possible.

It is noted that the frequency signal could be suitable coded to reduce the required bandwidth. To allow an even more accurate reconstruction of the audio signal, coded phase information could be transmitted as well.

In the above discussion it has been assumed that the envelope signal of only a single frequency band is transmitted. In another advantageous embodiment, however, the audio transmission device of the present invention further comprises a further first filter for selecting a further frequency range of the audio signal, and further detector means for detecting the envelope of an audio signal of the further frequency range and producing a corresponding further envelope signal, the oscillator signal and the further oscillator signal having different frequencies. That is, the device of the present invention may have several parallel branches, each designed for a certain frequency band, and each producing a corresponding envelope signal. The envelope signals may be transmitted using a single transmitter means. Alternatively, the device may comprise further transmitter means for transmitting the further envelope signal.

The present invention additionally provides an audio receiving device comprising:

receiver means for receiving a transmitted envelope signal, and

reconstruction means for reconstructing an audio signal on the basis of the envelope signal.

The audio receiving device of the present invention receives the transmitted envelope signal and reconstructs the original audio signal on the basis of the transmitted envelope signal. It should be noted that the reconstruction need not be perfect and that the reconstructed audio signal and the original audio signal may not be identical. However, the audio receiving device typically produces a loudspeaker signal that is very similar to the original audio signal and that has, for example, a substantially identical envelope.

In a preferred embodiment of the audio receiving device of the present invention the reconstruction means comprise an oscillator for producing an oscillator signal and a combination unit for combining the oscillator signal and the received envelope signal so as to produce a reconstructed signal. The combination unit may be constituted by a multiplier. The output signal of this combination unit therefore is an amplitude modulated signal, the amplitude modulation being determined by the transmitted envelope signal.

The oscillation frequency of the oscillator may be a predetermined, fixed frequency. The frequency could, for example, be set at the middle (median or average) frequency or the maximum (peak) frequency of the pass-band of the first filter referred to above. In this way, the oscillator frequency corresponds with the center of the pass-band of said filter, and therefore with the selected frequency range.

In a further advantageous embodiment, however, the oscillator is arranged for receiving a frequency control signal. That is, the frequency of the oscillator can be controlled by a frequency control signal that is fed to the oscillator. In this embodiment, the oscillator may be constituted by a VCO (Voltage Controlled Oscillator) known per se. The frequency control signal may be an external signal or a signal controlled by a variable resistor so as to allow tuning of the frequency. However, in an advantageous embodiment the audio receiving device further comprises a frequency control unit for producing the frequency control signal. This frequency control unit may be coupled to the transducer (loudspeaker) so as to derive the frequency control signal from transducer parameters, such as the (phase of the) current flowing through the transducer. In this way, frequency feedback may be provided. Alternatively, the receiver means is arranged for producing the frequency control signal. In this embodiment, the receiver means is arranged for receiving a frequency control signal that is transmitted by the audio transmission device.

The oscillator may further be arranged for receiving an amplitude control signal so as to control the amplitude of the oscillator signal. Alternatively, or additionally, the audio receiving device of the present invention may further comprise a further combination unit for combining the reconstructed audio signal with an amplitude control signal. This further combination unit may also be constituted by a multiplier.

The audio receiving device may also comprise visual indicator means for visualizing the reconstructed audio signal. Such indicator means may be constituted by a light or a LED (Light Emitting Diode).

As the audio receiving device does not require wires for connecting with the audio transmission device, it may be powered by an internal power source, such as a battery, thus eliminating all wires. The device may further comprise a transducer for rendering the reconstructed audio signal, although the transducer (or set of transducers) may also be external to the device. That is, the audio receiving device of the present invention may constitute a unit to which transducers may be connected.

In a particularly advantageous embodiment, the at least one transducer is arranged for operating at its resonance frequency. By operating at or near its resonance frequency, the efficiency of the transducer can be very high, thus requiring very little electrical input power to produce a substantial electrical output power. Such embodiments are particularly suitable for being battery-powered.

In a very advantageous embodiment in which the at least one transducer may be arranged for operating at its resonance frequency, a frequency control unit is provided for controlling the oscillator frequency in such a way that the oscillator frequency is kept substantially equal to the resonance frequency of the transducer. The frequency control unit is preferably coupled to the transducer, either electrically or mechanically.

The present invention additionally provides an audio reproduction system comprising an audio transmission device and an audio receiving device as defined above. Such an audio reproduction system may be incorporated in, for example, a music center (home stereo system), home cinema system, or television apparatus, but may also be incorporated in musical instruments such as electronic organs and synthesizers. Accordingly, the present invention also provides a television apparatus comprising an audio reproduction system as defined above.

The present invention further provides an adaptation device for adapting a frequency range of an audio signal to a transducer, the device comprising:

detection means for detecting first signal components in a first audio frequency range,

generator means for generating second signal components in a second audio frequency range, and

control means for controlling the amplitude of the second signal components in response to the amplitude of the first signal components,

wherein:

the second audio frequency range is substantially narrower than the first audio frequency range,

the transducer has a maximum efficiency at the second audio frequency range, and

the amplitude of the first signal components is transmitted from the detection means to the control means over a communication link.

Such an adaptation device allows a first frequency range to be mapped on a second, narrower frequency range so as to utilize a higher transducer efficiency and/or sensitivity in the second frequency range.

Advantageously, the second frequency range is comprised in the first frequency range. This means that effectively the first frequency range is reduced in bandwidth.

The adaptation device of the present invention is particularly suitable for lower audio frequency ranges, although the device is not so limited. For example, the first audio frequency range may have an upper boundary not exceeding 200 Hz, preferably not exceeding 150 Hz, more preferably approximately 120 Hz. In a further preferred embodiment, the second audio frequency range spans less than 50 Hz, preferably less than 10 Hz, more preferably less than 5 Hz. It will be clear that a narrow second frequency range allows economical transmission means to be used. As mentioned above, the communication link may advantageously be a wireless link.

The adaptation device of the present invention may further comprise means for determining the second audio frequency range on the basis of transducer properties.

The present invention also provides a method of transmitting an audio signal, the method comprising the steps of:

detecting the envelope of an audio signal and producing a corresponding envelope signal,

transmitting the envelope signal using a transmitter,

receiving a transmitted envelope signal using a receiver, and

reconstructing the audio signal on the basis of the envelope signal.

The method of the present invention may further comprise the step of selecting a frequency range of the audio signal. In particular, this frequency range is selected prior to detecting the envelope.

The present invention additionally provides a computer program product for carrying out the method as defined above. A computer program product may comprise a carrier, such as a CD, a DVD or a magnetic disc, on which a software program is stored. The software program is designed for causing a suitable processor to carry out the method steps of the present invention. The processor may be constituted by a general purpose computer (“PC”) or a dedicated processor.

The present invention will further be explained below with reference to exemplary embodiments illustrated in the accompanying drawings, in which:

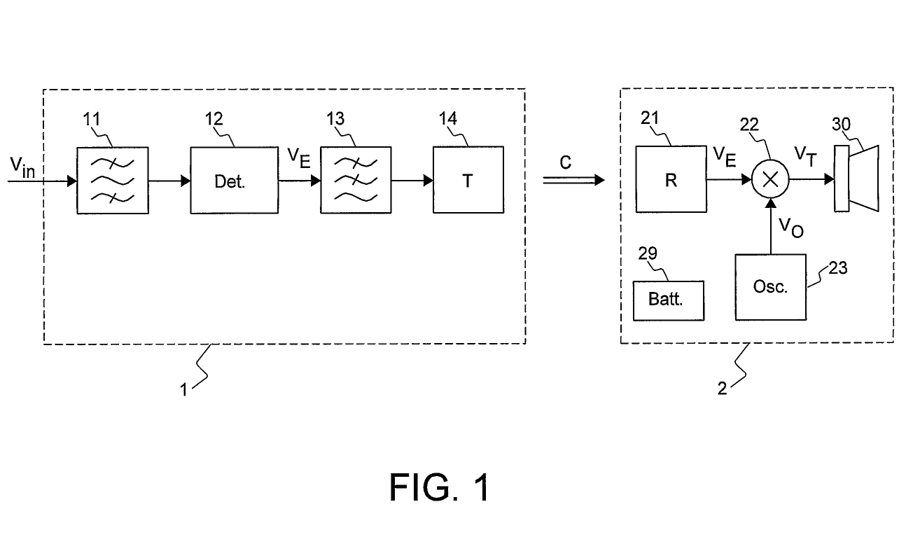

FIG. 1 schematically shows an audio reproduction system according to the present invention comprising a first embodiment of a transmitter device and a first embodiment of a receiver device.

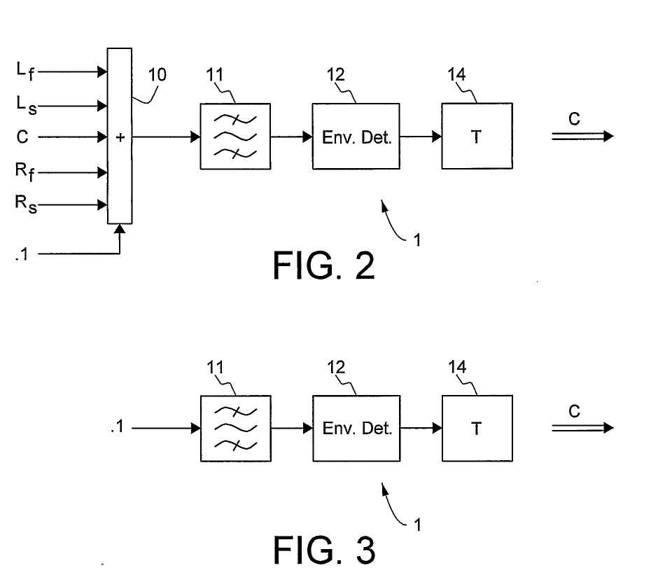

FIG. 2 schematically shows a second embodiment of a transmitter device according to the present invention.

FIG. 3 schematically shows a third embodiment of a transmitter device according to the present invention.

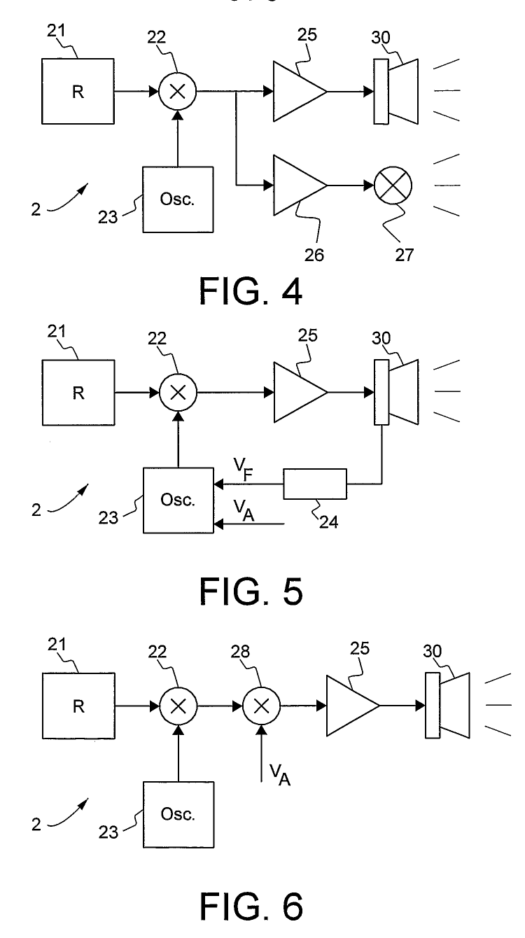

FIG. 4 schematically shows a second embodiment of a receiver device according to the present invention.

FIG. 5 schematically shows a third embodiment of a receiver device according to the present invention.

FIG. 6 schematically shows a fourth embodiment of a receiver device according to the present invention.

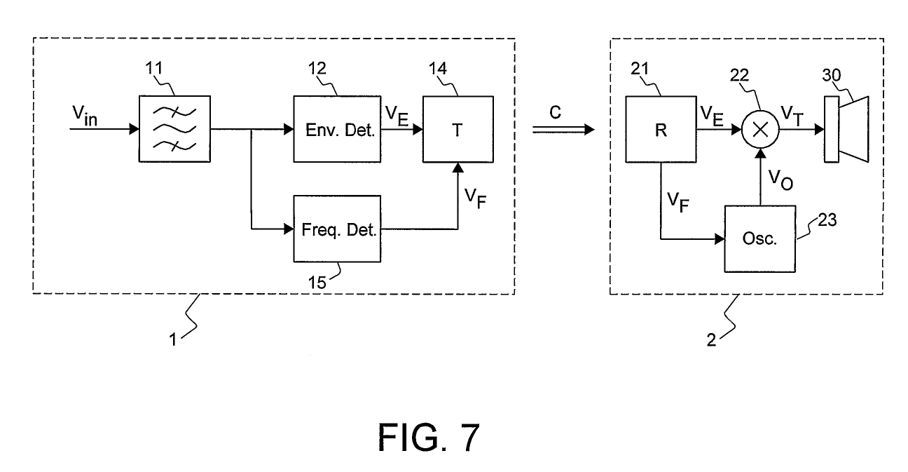

FIG. 7 schematically shows an alternative embodiment of an audio reproduction system according to the present invention.

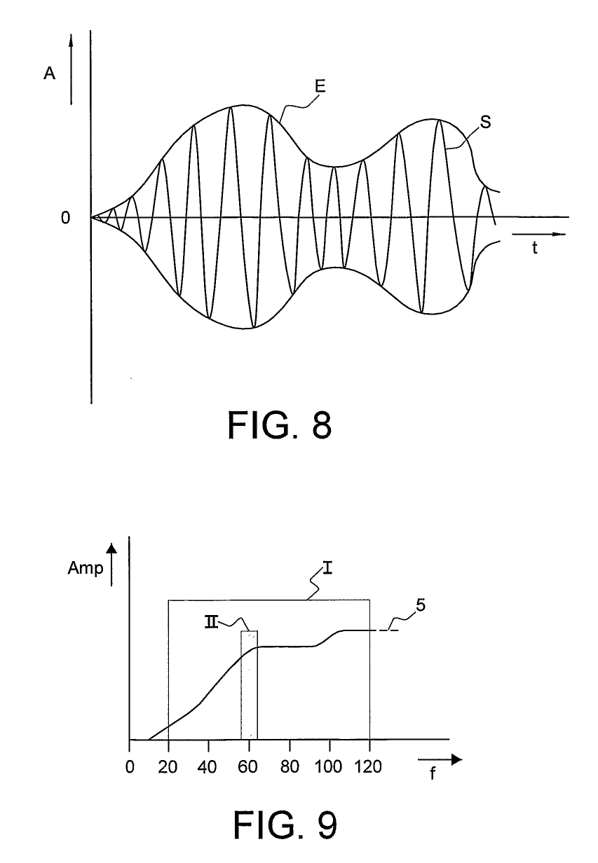

FIG. 8 schematically shows an audio signal and its envelope as used in the present invention.

FIG. 9 schematically shows a first frequency range that is mapped on a second frequency range using an audio reproduction system of the present invention.

The audio reproduction system shown merely by way of non-limiting example in FIG. 1 comprises a transmitter device 1 and a receiver device 2 which are designed to co-operate to produce sound, in particular music.

The transmitter device 1 comprises a first filter 11, a detector 12, a second filter 13 and a transmitter (T) unit 14. The first filter 11, which in the embodiment shown is a band-pass filter, selects a frequency range of the input audio signal Vᵢₙ. In typical embodiments, this selected range will be the “bass” frequency range and the first filter 11 may have a pass-band from approx. 20 Hz to approx. 120 Hz. It will be understood that other ranges are possible, for example from 0 Hz (DC) to 200 Hz, or from 10 Hz to 80 Hz.

The detector 12 detects the envelope of the audio signal in the selected frequency range and outputs an envelope signal that represents the envelope. The detector 12 may be constituted by a peak detector, an envelope detector or another known detector. In a very economical embodiment, the envelope detector is constituted by a diode and a capacitor.

An exemplary audio signal S and its envelope E are schematically illustrated in FIG. 8. As can be seen, the envelope E has a much lower frequency and a much narrower bandwidth than the audio signal S itself. While the audio signal S may have a bandwidth of approximately 100 Hz (ranging from 20 Hz to 120 Hz, for example), the corresponding envelope E may have a bandwidth of only 10 Hz (ranging from 0 Hz to 10 Hz, for example). The present invention utilizes the fact that the envelope of an audio signal has a much narrower bandwidth than the entire audio signal. As a result, the envelope may be transmitted using a narrow-band link.

Returning to FIG. 1, the envelope signal passes through the (optional) second filter 13 before being fed to the transmitter unit 14. This second filter 13, which typically is a low-pass filter, removes any undesired frequency components from the envelope signal, thus further reducing the bandwidth of the envelope signal.

The transmitter unit 14 receives the envelope signal and transmits this signal to the receiver unit 21 of the receiver device 2. As the envelope signal has a relatively narrow bandwidth, as mentioned above, a narrow-band and therefore inexpensive transmission link is sufficient to transmit this signal. For instance, a ZigBee® transmitter and receiver unit may be used. Such units are typically used for transmitting control characters. Other types of links may also be used, for example transmitters and receivers based on the well-known Bluetooth® technology, offering a wider bandwidth. However, Bluetooth® is presently much more expensive to implement than ZigBee®.

In general, the invention proposes to use a narrowband link between the transmitter device 1 and the receiver device 2. A typical link will be wireless, for example using infra-red light, ultrasound or electromagnetic waves (radio link), although wired links may also be used.

The exemplary receiver device 2 shown in FIG. 1 comprises a receiver (R) unit 21, a combination unit 22, an oscillator unit 23, a transducer (loudspeaker) unit 30 and a battery unit 29.

The receiver unit 21 is the counterpart of the transmitter unit 14 of the transmitter device 1. The receiver unit 21 receives the envelope signal V_{E} (E in FIG. 8) that is transmitted via the communication link C and feeds the envelope signal to the combination unit 22. As mentioned above, the communication link C preferably is a wireless link, such as a ZigBee® link.

The oscillator 23 generates a sine signal having a frequency that corresponds with the pass-band of the first filter 11 and that coincides, for example, with the center frequency of this pass-band. This oscillation signal V_{O} is combined with the envelope signal V_{E} in the combination unit 22, which in the preferred embodiments is constituted by a multiplier. The resulting signal V_{T} is therefore amplitude modulated: its amplitude (envelope) is determined by the envelope signal produced by the receiver unit 21, while its frequency is determined by the oscillator 23. This amplitude modulated signal V_{T}, which is a reconstruction of the original signal Vᵢₙ, is fed to the transducer (loudspeaker) 30. The reconstruction of a band-limited audio signal is discussed in more detail in European Patent Application EP 03103398.8 [PHNL031136], which Application is herewith incorporated in this document.

It can be seen that the present invention provides a very economical way of transmitting an audio signal. First a frequency band is selected (first filter 11), then the envelope of the signal contained in this selected frequency band is determined, subsequently the relatively narrow-band envelope signal is transmitted using an inexpensive communication channel, and finally the original signal is reconstructed using the transmitted envelope signal and an oscillator signal.

It is noted that the loudspeaker 30 of FIG. 1 may be replaced with a set of loudspeakers, or one or more other suitable transducers, such as so-called “shakers”. In a particularly advantageous embodiment, the loudspeaker (transducer) 30 is designed to operate at its resonance frequency. Suitable transducers of this type are described in European Patent Application EP 03103396.2 [PHNL031135]. A transducer designed to operate at its resonance frequency is typically very efficient, requiring a low (electrical) input power to generate a high (acoustical) output power. The oscillator 23, which may be a voltage-controlled oscillator (VCO), is set at the resonance frequency of the transducer 30. The resonance frequency, and hence the oscillator frequency, are within the pass-band of the first filter 11. A feed-back connection may be used between the transducer 30 and the oscillator 23 to tune the oscillator frequency, as will be later explained in more detail with reference to FIG. 5.

If a resonant transducer is used, relatively little power is required to drive the receiver device 2 which, in the embodiment shown, includes the transducer 30. This allows the receiver device 2 to be powered by an internal power source 29, such as a battery, thus eliminating the need for any wires. In this way, a completely wireless receiver device 2 is achieved. It will be clear that such a wireless receiver device, in which at least one loudspeaker 30 is accommodated, has great advantages over existing audio systems where wires have to be used to connect the loudspeakers with the main unit (amplifier) of the audio system and possibly also with an external power supply, such as an AC power socket.

Although a battery-powered receiver device 2 is preferred, the invention is not so limited and other embodiments may be externally (for example AC) powered, in which case the battery 29 may be omitted. Still, a wireless communication channel C removes the need for leads connecting the loudspeaker to the main unit (amplifier) of the audio system.

In the embodiment of FIG. 1 the loudspeaker (in general: transducer) 30 is shown to be contained in the receiver device 2. This is, however, not essential and embodiments can be envisaged in which the loudspeaker(s) 30 are contained in a separate housing, connected to the receiver device 2 by suitable leads.

The transmitted device 1 and the receiver device 2 may be implemented in analog or digital technology. Those skilled in the art will appreciate that digital embodiments may require analog/digital (A/D) and/or digital/analog (D/A) converters which are well known in the art. In a digital embodiment of receiver device 2, for example, a D/A converter would be inserted between the combination unit 22 and the loudspeaker 30.

An alternative embodiment of the transmitter device 1 is schematically illustrated in FIG. 2. In this embodiment, the (optional) second filter 13 has been omitted. As mentioned above, this filter merely serves to remove any unwanted frequency components, such as artifacts introduced by the envelope detector 12, and is not essential to the invention.

In the embodiment of FIG. 2, the input signal (Vᵢₙ in FIG. 1) is derived from a typical set of audio input signals as defined by the standard commonly referred to as “5.1”. These signals comprise a left front signal L_{f}, a left surround signal Lₛ, a center signal C, a right front signal R_{f}, a right surround signal Rₛ, and an auxiliary bass (subwoofer) signal denoted “.1”. These signals are added in addition unit 10, whose output signal is fed to the first filter 11. In this embodiment, all audio signals are combined (for example by adding) to form the input signal of the first filter 11. This input signal will therefore contain all available audio frequencies.

It is noted that instead of a simple addition of the signals, the addition unit 10 may carry out a weighed addition in which some signals (for example signal “.1”) contribute more to the filter input signal than other channels.

When the audio reproduction system of the present invention is used to reproduce only low (bass) frequencies, the first filter 11 will typically remove all higher frequencies and the signal passed by this filter will be primarily based upon the subwoofer signal “.1”. Accordingly, in the embodiment of FIG. 3 the addition circuit 10 has been omitted and only the subwoofer signal “.1” is input to the first filter 11.

The embodiment of the receiver unit 2 shown in FIG. 4 comprises a first amplifier 25 and a second amplifier 26. The first amplifier 25 serves to amplify the signal output by the combination unit 22 before it is fed to the loudspeaker (transducer) 30. The second amplifier 26 serves to drive a visual indicator, such as a light bulb 27 or a LED (light emitting diode). The exemplary light bulb 27 will flicker in the rhythm of the sound that is reproduced by the loudspeaker 30 and will thus provide an additional entertainment stimulus. In the example shown in FIG. 4 the input of the second amplifier 26 is connected to the output of the combination unit 22. However, this is not essential and the input of the second amplifier 26 may instead be connected to the output of the receiver unit 21.

The receiver unit 2 of FIG. 5 also has a (first) amplifier 25. In addition, a feed-back path is provided from the loudspeaker 30 to the oscillator 23 so as to adjust the oscillator frequency. A frequency control unit 24 converts a suitable transducer parameter, such as the current or the (instantaneous) impedance, into a frequency control signal V_{F} that is fed to the oscillator 23. The frequency control unit 24 is typically designed in such a way that the oscillation frequency is substantially equal to the resonance frequency of the transducer 30. Advantageously, the frequency control unit 24 may use the phase shift introduced by the transducer 30 to derive the frequency control signal V_{F}. Further details of driving a transducer at its resonance frequency are discussed in European Patent Application EP 04102314.4 [PHAT040025], which Application is herewith incorporated in this document.

In the embodiment of FIG. 5 not only the frequency but also the amplitude of the oscillator signal may be controlled. In the example shown, an external amplitude control signal V_{A} is supplied to the oscillator 23 to adjust the amplitude of the oscillator signal and to thereby control the level of the loudspeaker signal. Alternatively, the (first) amplifier 25 may have an adjustable gain, in which case the amplitude control signal V_{A} may be fed to this amplifier.

Another alternative sound level control mechanism is presented in FIG. 6, where an additional combination unit 28 is provided between the original combination unit 22 and the (first) amplifier 25. In this additional combination unit 28, the output signal of the original (first) combination unit 22 and the amplitude control signal V_{A} are combined (that is, preferably multiplied) to adjust the signal level and hence the sound level. It is noted that the positions of the combination units 22 and 28 may be reversed, thus first adjusting the signal level of the envelope signal and then combining the envelope signal and the oscillator signal. Alternatively, the additional (second) combination unit 28 may be positioned between the oscillator 23 and the (first) combination unit 22.

As mentioned above, the audio reproduction system of the present invention is preferably designed for reproducing low frequency (“bass”) sound using a transducer designed for being driven at approximately its resonance frequency. However, the present invention is not so limited and embodiments can be envisaged in which not only a single frequency band but multiple frequency bands can be reproduced, these multiple frequency bands possibly covering the entire audio frequency spectrum. In such a multiple frequency band embodiment, multiple transmitter devices 1 and receiver devices 2 may be arranged in parallel, each designed for a specific frequency band. The first filters 11 may have adjacent or slightly overlapping pass bands, which correspond with the respective oscillator frequencies. There may be individual transmitter units 14 and receiver units 21 for each frequency band, or transmitter units and receiver units may be shared between frequency bands.

In a further alternative embodiment, the oscillator frequency is not pre-set or derived from the properties and/or the behavior of the transducer, but is transmitted together with the envelope signal. Such an embodiment is illustrated in FIG. 7, where a frequency detector 15 is arranged in parallel with the envelope detector 12. The frequency detector 15 may be a detector known per se which detects the frequency of the audio signal by, for example, counting zero-crossings. It will be understood that more sophisticated frequency detectors may also be used, for example detectors that perform an FFT (Fast Fourier Transform) on a number of signal samples and determine the peak(s) of the frequency spectrum.

The frequency detector 15 produces a frequency signal V_{F} that is indicative of the (dominant) frequency of the input signal Vᵢₙ after filtering by the (first) filter 11. This frequency signal V_{F} is fed to the transmitter 14, together with the envelope signal V_{E} produced by the envelope detector 12. In the embodiment shown, a single transmitter 14 is used to transmit both the envelope signal V_{E} and the frequency signal V_{F}. However, in other embodiments (not shown) the envelope signal V_{E} and the frequency signal V_{F} may be transmitted separately, using individual transmitters.

In the receiver device 2 of FIG. 7 the receiver (R) unit 21 is shown to be connected to both the combination unit 22 and the oscillator 23 to supply the envelope signal V_{E} and the frequency signal V_{F} respectively. Accordingly, the frequency of the oscillator (which preferably is a voltage controlled oscillator, VCO) is controlled by the frequency signal V_{F}.

An exemplary audio input signal (Vᵢₙ in FIGS. 1 and 7) and its envelope are schematically illustrated in FIG. 8, where the signal amplitude A is shown as a function of the time t. The temporal magnitude of the signal S is defined by the envelope E. As can be seen, the frequency and the bandwidth of the envelope E are much lower than of the signal S. Transmitting the envelope E therefore requires less bandwidth than transmitting the actual signal S. The present invention utilizes this principle to provide a very economical audio signal transmission.

The audio reproduction system of the present invention may map a first frequency range on a second, narrower frequency range. In FIG. 9 a graph showing an exemplary audio frequency distribution is schematically depicted. The graph 5 indicates the amplitude Amp (vertical axis) of an audio signal at a particular frequency f (horizontal axis). As shown, the audio signal contains virtually no signal components below approximately 10 Hz. As the following discussion will focus on the low-frequency part of the graph 5, the mid- and high-frequency parts of the graph have been omitted for the sake of clarity of the illustration.

In the audio reproduction system of the present invention, a first frequency range is mapped onto a second, smaller frequency range which is preferably contained in the first frequency range. In the non-limiting example of FIG. 9, a first frequency range I is the range from 20 Hz to 120 Hz, while a second range II is the range around 60 Hz, for example 55-65 Hz. This first range I substantially covers the “low-frequency” part of an audio signal, whereas the second range II of FIG. 9 is chosen so as to correspond with a particular transducer, such as a loudspeaker, and will depend on the characteristics of the transducer. This second range II corresponds with the frequencies at which the transducer is most efficient, resulting in the highest sound production.

It will be understood that the size (bandwidth) of the second range II may also depend on the characteristics of the transducer(s). A transducer or array of transducers having a wider range of frequencies at which it is most efficient (possibly multiple resonance frequencies) will benefit from a wider second range II. Transducers or arrays of transducers having a single most efficient frequency (typically the resonance frequency) may benefit from an extremely narrow second range II as this will concentrate all energy in said single frequency.

It is noted that in the example shown the second range II is located within the first range I. This means that the first range I is effectively compressed and that no frequencies outside the first range are affected.

The present invention may be used in consumer audio (stereo) systems, home cinema systems, television sets, car audio systems, portable audio systems, other sound reproduction systems, laptop computers, desk-top computers, and in electronic musical instruments such as electronic organs and synthesizers.

It is noted that features of any of the embodiments discussed above may be combined with features of any of the other embodiments. The frequency feedback (frequency control unit 24) shown in FIG. 5, for example, may be added to any of the embodiments of FIGS. 1, 4, 6 and 7. Similarly, the volume control (amplitude control signal V_{A}) of FIG. 6 may also be used in the embodiments of FIGS. 1, 5 and even 7. The amplifier 25 of FIGS. 5, 6 and 7 may be present as shown, but may also be omitted as illustrated in FIG. 1. Those skilled in the art will realize that many more combinations of features may be made without requiring any inventive activity.

The present invention is based upon the insight that the envelope of an audio signal typically has a much narrower bandwidth than the audio signal itself. As a result, the envelope can be transmitted using a narrow-band link. The present invention benefits from the further insight that an audio signal can be substantially reconstructed from its envelope by multiplying the envelope by a signal having the original frequency of the audio signal.

It is noted that any terms used in this document should not be construed so as to limit the scope of the present invention. In particular, the words “comprise(s)” and “comprising” are not meant to exclude any elements not specifically stated. Single (circuit) elements may be substituted with multiple (circuit) elements or with their equivalents.

Although the audio system of the present invention is particularly suitable for producing music signals, it can also be used for producing other sound signals, such as voice signals. The present invention may be applied in stereo systems, television apparatus, home cinema systems, car stereo systems, public address systems, and other sound reproduction systems.

It will be understood by those skilled in the art that the present invention is not limited to the embodiments illustrated above and that many modifications and additions may be made without departing from the scope of the invention as defined in the appending claims.

1. An audio transmission device (1) comprising:
detector means (12) for detecting the envelope of an audio signal (Vᵢₙ) and producing a corresponding envelope signal (V_{E}), and
transmitter means (14) for transmitting the envelope signal.

2. The audio transmission device according to claim 1, further comprising a first filter (11) for selecting a frequency range of the audio signal (Vᵢₙ).

3. The audio transmission device according to claim 2, wherein the first filter (11) is arranged for selecting bass frequencies, preferably in a range from 0 Hz to 200 Hz, more preferably from 20 Hz to 120 Hz.

4. The audio transmission device according to claim 1, further comprising a second filter (13) for filtering the envelope signal (V_{E}).

5. The audio transmission device according to claim 1, further comprising an addition means (10) for adding audio signals.

6. The audio transmission device according to claim 1, wherein the transmitter means (14) is arranged for wireless transmission, preferably using ZigBee® technology.

7. The audio transmission device according to claim 1, further comprising additional detector means (15) for detecting the frequency of the audio signal and producing a corresponding frequency signal (V_{F}), and wherein the transmitter means (14) are arranged for transmitting the frequency signal.

8. The audio transmission device according to claim 2, further comprising a further first filter for selecting a further frequency range of the audio signal (Vᵢₙ), and further detector means for detecting the envelope of an audio signal of the further frequency range and producing a corresponding further envelope signal.

9. The audio transmission device according to claim 8, further comprising further transmitter means for transmitting the further envelope signal.

10. An audio receiving device (2) comprising:
receiver means (21) for receiving a transmitted envelope signal (V_{E}), and
reconstruction means (22, 23) for reconstructing an audio signal on the basis of the envelope signal.

11. The audio receiving device according to claim 10, wherein the reconstruction means comprise an oscillator (23) for producing an oscillator signal (V_{O}) and a combination unit (22) for combining the oscillator signal (V_{O}) and the received envelope signal (V_{E}) so as to produce a reconstructed signal (V_{T}).

12. The audio receiving device according to claim 10, wherein the oscillator (23) is arranged for receiving a frequency control signal (V_{F}).

13. The audio receiving device according to claim 12, wherein the receiver means (21) is arranged for producing the frequency control signal (V_{F}).

14. The audio receiving device according to claim 12, further comprising a frequency control unit (24) for producing the frequency control signal (V_{F}), the frequency control unit preferably being coupled to the transducer (30).

15. The audio receiving device according to claim 14, wherein the frequency control unit (24) is arranged for keeping the frequency of the oscillator signal (V_{O}) substantially equal to a resonance frequency of the transducer (30).

16. The audio receiving device according to claim 10, wherein the transducer (30) is arranged for operating at its resonance frequency.

17. The audio receiving device according to claim 10, wherein the oscillator (23) is arranged for receiving an amplitude control signal (V_{A}).

18. The audio receiving device according to claim 10, further comprising a further combination unit (28) for combining the reconstructed audio signal (V_{T}) with an amplitude control signal (V_{A}).

19. The audio receiving device according to claim 10, further comprising visual indicator means (27) for visualizing the reconstructed audio signal.

20. The audio receiving device according to claim 10, which is powered by an internal power source (29).

21. The audio receiving device according to claim 10, further comprising a transducer (30) for rendering the reconstructed audio signal.

22. The audio receiving device according to claim 10, further comprising a further oscillator for producing an further oscillator signal and a further combination unit for combining the further oscillator signal and a received further envelope signal so as to produce a reconstructed signal, the oscillator signal (V_{O}) and the further oscillator signal having different frequencies.

23. An audio reproduction system comprising an audio transmission device (1) according to claim 1.

24. A television apparatus comprising an audio reproduction system according to claim 23.

25. A device (1) for adapting a frequency range of an audio signal to a transducer (30), the device comprising:
detection means (12) for detecting first signal components in a first audio frequency range (I),
generator means (23) for generating second signal components in a second audio frequency range (II), and
control means (22) for controlling the amplitude of the second signal components in response to the amplitude of the first signal components,
wherein:
the second audio frequency range (II) is substantially narrower than the first audio frequency range (I),
the transducer (30) has a maximum efficiency at the second audio frequency range (II), and
the amplitude of the first signal components is transmitted from the detection means (13) to the control means (21) over a communication link (C).

26. The device according to claim 25, wherein the second frequency range (II) is comprised in the first frequency range (I).

27. The device according to claim 25, wherein the first audio frequency range (I) has an upper boundary not exceeding 200 Hz, preferably not exceeding 150 Hz, more preferably approximately 120 Hz.

28. The device according to claim 25, wherein the second audio frequency range (II) spans less than 50 Hz, preferably less than 10 Hz, more preferably less than 5 Hz.

29. The device according to claim 25, wherein the communication link (C) is a wireless link.

30. The device according to claim 25, further comprising means (24) for determining the second audio frequency range (II) on the basis of transducer properties.

31. A method of transmitting an audio signal, the method comprising the steps of:
detecting the envelope of an audio signal (Vᵢₙ) and producing a corresponding envelope signal (V_{E}),
transmitting the envelope signal (V_{E}) using a transmitter (14),
receiving a transmitted envelope signal using a receiver (21), and
reconstructing the audio signal on the basis of the envelope signal.

32. The method according to claim 31, further comprising the step of selecting a frequency range of the audio signal (Vᵢₙ).

33. The method according to claim 31, wherein the transmitter (14) is arranged for wireless transmission, preferably using ZigBee® technology.

34. The method according to claim 31, wherein the reconstructed audio signal (V_{T}) is fed to a transducer (30) designed to operate at a resonance frequency.

35. A computer program product for carrying out the method according to claim 31.
